(19) United States
(12) Patent Application Publication
(10) Pub. No.: US 2024/0359377 A1
(43) Pub. Date: Oct. 31, 2024

(54) Material Dispensing Device And Injection Molding Apparatus

(71) Applicant: SEIKO EPSON CORPORATION, Tokyo (JP)

(72) Inventor: Kenta ANEGAWA, Matsumoto (JP)

(21) Appl. No.: 18/645,770

(22) Filed: Apr. 25, 2024

(30) Foreign Application Priority Data
Apr. 28, 2023 (JP) 2023-074639

(51) Int. Cl. B29C 45/17; B29C 45/47

(52) U.S. Cl. CPC B29C 45/1753; B29C 45/47

(57) ABSTRACT

A material dispensing device includes: a plasticization unit including a screw and a heater and configured to generate a shaping material by plasticizing at least a part of a material; a cylinder coupled to a flow path configured to allow the shaping material to flow and extending in a direction intersecting a longitudinal direction of the flow path; a plunger provided in the cylinder; a drive unit configured to drive the plunger; and a control unit configured to control the plasticization unit and the drive unit, in which when the material is replaced from a first material to a second material different from the first material, the control unit performs cleaning processing of circulating the shaping material generated by plasticizing the second material through the flow path by rotating the screw in a state in which a tip of the plunger on a flow path side is located in the flow path.

The present application is based on, and claims priority from JP Application Serial Number 2023-074639, filed Apr. 28, 2023, the disclosure of which is hereby incorporated by reference herein in its entirety.

### BACKGROUND

### 1. Technical Field

The present disclosure relates to a material dispensing device and an injection molding apparatus.

### 2. Related Art

A material dispensing device that dispenses a plasticized material has been known. Such a material dispensing device is applied to an injection molding apparatus or the like.

For example, JP-A-2020-157601 discloses a material supply device including a plasticization unit configured to convey a thermoplastic resin while heating the thermoplastic resin and an injection unit configured to inject a molten resin supplied from the plasticization unit by sliding of an injection plunger in an injection cylinder.

JP-A-2020-157601 is an example of the related art.

In the material supply device described above, when materials are replaced, a material before the replacement may remain at a tip of the plunger.

### SUMMARY

In an aspect of a material dispensing device according to the present disclosure, the material dispensing device includes:
a plasticization unit including a screw and a heater and configured to generate a shaping material by plasticizing at least a part of a material;
a cylinder coupled to a flow path configured to allow the shaping material to flow and extending in a direction intersecting a longitudinal direction of the flow path;
a plunger provided in the cylinder;
a drive unit configured to drive the plunger; and
a control unit configured to control the plasticization unit and the drive unit, in which
when the material is replaced from a first material to a second material different from the first material, the control unit performs cleaning processing of circulating the shaping material generated by plasticizing the second material through the flow path by rotating the screw in a state in which a tip of the plunger on a flow path side is located in the flow path.

### BRIEF DESCRIPTION OF THE DRAWINGS

FIG. 1 is a side view schematically showing an injection molding apparatus according to an embodiment.

FIG. 2 is a cross-sectional view schematically showing the injection molding apparatus according to the embodiment.

FIG. 3 is a perspective view schematically showing a flat screw of the injection molding apparatus according to the embodiment.

FIG. 4 is a view schematically showing a barrel of the injection molding apparatus according to the embodiment.

FIG. 5 is a flowchart showing processing of a control unit of the injection molding apparatus according to the embodiment.

FIG. 6 is a cross-sectional view showing the processing of the control unit of the injection molding apparatus according to the embodiment.

FIG. 7 is a cross-sectional view showing the processing of the control unit of the injection molding apparatus according to the embodiment.

FIG. 8 is a cross-sectional view showing processing of a control unit of an injection molding apparatus according to a first modification of the embodiment.

FIG. 9 is a cross-sectional view showing the processing of the control unit of the injection molding apparatus according to the first modification of the embodiment.

FIG. 10 is a side view schematically showing a plunger of an injection molding apparatus according to a second modification of the embodiment.

FIG. 11 is a side view schematically showing a plunger of the injection molding apparatus according to the second modification of the embodiment.

FIG. 12 is a cross-sectional view schematically showing a three-dimensional shaping apparatus according to the embodiment.

### DESCRIPTION OF EMBODIMENTS

Hereinafter, a preferred embodiment according to the present disclosure will be described in detail with reference to the drawings. The embodiment to be described below does not unduly limit the contents of the present disclosure described in the claims. In addition, not all configurations to be described below are necessarily essential components of the present disclosure.

### 1. Injection Molding Apparatus

### 1.1. Overall Configuration

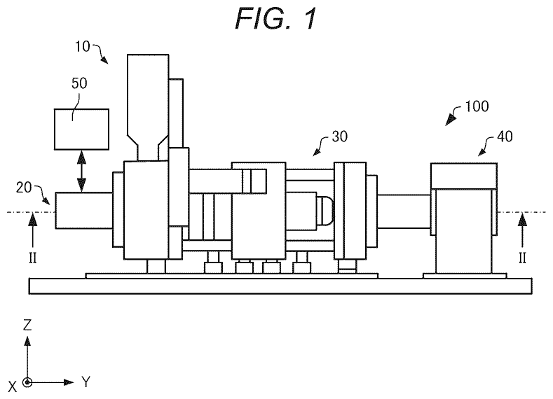

First, an injection molding apparatus according to the embodiment will be described with reference to the drawings. FIG. 1 is a side view schematically showing an injection molding apparatus 100 according to the embodiment. FIG. 1 shows an X axis, a Y axis, and a Z axis as three axes orthogonal to one another. An X-axis direction and a Y-axis direction are, for example, horizontal directions. A Z-axis direction is, for example, a vertical direction.

As shown in FIG. 1, the injection molding apparatus 100 includes a material supply unit 10, a material dispensing device 20, a mold unit 30, a mold clamping unit 40, and a control unit 50.

The material supply unit 10 supplies a material as a raw material to the material dispensing device 20. The material supply unit 10 is implemented by, for example, a hopper. A shape of the material supplied from the material supply unit 10 is, for example, a pellet shape or a powder shape.

The material dispensing device 20 plasticizes the material supplied from the material supply unit 10 to form a shaping material. Then, the material dispensing device 20 dispenses the shaping material toward the mold unit 30.

The term “plasticize” is a concept including melting and means changing from a solid state to a flowable state. Specifically, in a case of a material in which glass transition occurs, the term “plasticize” refers to setting a temperature of the material equal to or higher than a glass transition point. In a case of a material in which the glass transition does not occur, the term “plasticize” refers to setting the temperature of the material equal to or higher than a melting point.

A cavity corresponding to a shape of a molded article is formed in the mold unit 30. The shaping material injected from the material dispensing device 20 flows into the cavity. Then, the shaping material is cooled and solidified, and the molded article is generated.

The mold clamping unit 40 opens and closes the mold unit 30. The mold clamping unit 40 opens the mold unit 30 after the shaping material is cooled and solidified. Accordingly, the molded article is dispensed to an outside.

The control unit 50 is implemented by, for example, a computer including a processor, a main storage device, and an input and output interface for inputting and outputting signals from and to the outside. The control unit 50 exerts various functions by the processor executing programs read into the main storage device. Specifically, the control unit 50 controls the material dispensing device 20 and the mold clamping unit 40. The control unit 50 may be implemented by a combination of a plurality of circuits instead of the computer.

### 1.2. Specific Configuration

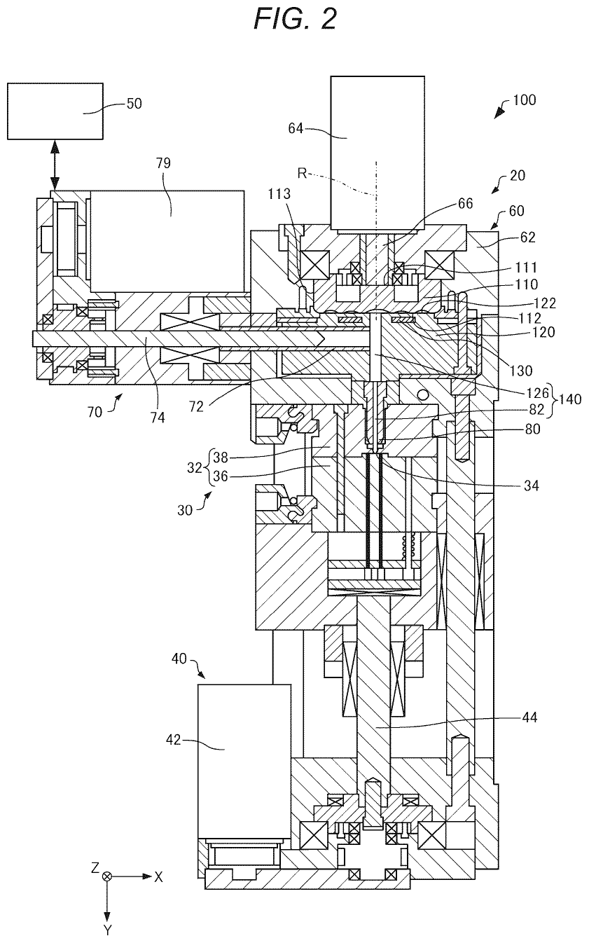

FIG. 2 is a cross-sectional view taken along a line II-II in FIG. 1 schematically showing the injection molding apparatus 100. As shown in FIG. 2, the material dispensing device 20 includes, for example, a plasticization unit 60, an injection mechanism 70, and a nozzle 80.

The plasticization unit 60 is configured to plasticize at least a part of the material supplied from the material supply unit 10, generate a flowable paste-shaped shaping material, and guide the generated shaping material to the injection mechanism 70. The plasticization unit 60 includes, for example, a screw case 62, a drive motor 64, a flat screw 110, a barrel 120, and a heater 130.

The screw case 62 is a housing that accommodates the flat screw 110. The flat screw 110 is accommodated in a space surrounded by the screw case 62 and the barrel 120.

The drive motor 64 is coupled to the screw case 62. The drive motor 64 rotates the flat screw 110. The drive motor 64 is, for example, a servomotor. A shaft 66 of the drive motor 64 is coupled to the flat screw 110. The drive motor 64 is controlled by the control unit 50.

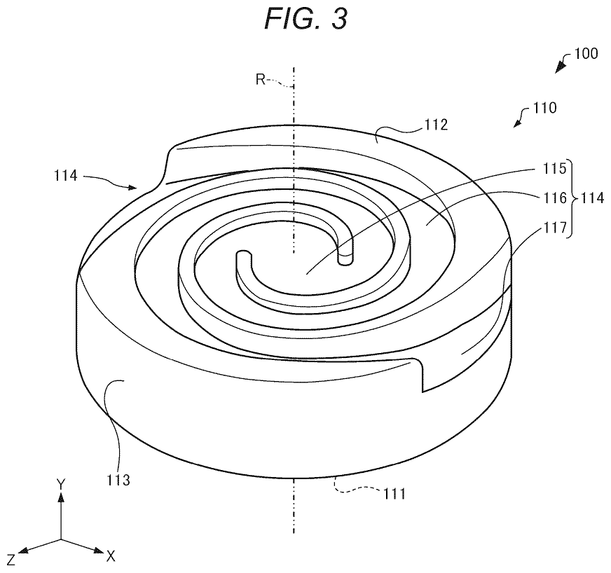

The flat screw 110 has a substantially cylindrical shape in which a size in a direction of a rotation axis R is smaller than a size in a direction orthogonal to the direction of the rotation axis R. In a shown example, the rotation axis R is parallel to the Y axis. The flat screw 110 is rotated about the rotation axis R by a torque generated by the drive motor 64. The flat screw 110 has, for example, a shaft surface 111 to which the shaft 66 is coupled, a groove formation surface 112 on an opposite side from the shaft surface 111, and a coupling surface 113 connecting the shaft surface 111 and the groove formation surface 112. Here, FIG. 3 is a perspective view schematically showing the flat screw 110. For convenience, FIG. 3 shows a state in which an upper-lower positional correlation is reversed from a state shown in FIG. 2.

As shown in FIG. 3, first grooves 114 are formed in the groove formation surface 112 of the flat screw 110. The first groove 114 includes, for example, a central portion 115, a coupling portion 116, and a material introduction portion 117. The central portion 115 faces a communication hole 126 formed in the barrel 120. The central portion 115 communicates with the communication hole 126. The coupling portion 116 couples the central portion 115 and the material introduction portion 117. In the shown example, the coupling portion 116 is formed in a spiral shape from the central portion 115 toward an outer periphery of the groove formation surface 112. The material introduction portion 117 is formed in the outer periphery of the groove formation surface 112. That is, the material introduction portion 117 is formed in the coupling surface 113 of the flat screw 110. The material supplied from the material supply unit 10 is introduced from the material introduction portion 117 into the first groove 114, passes through the coupling portion 116 and the central portion 115, and is conveyed to the communication hole 126 formed in the barrel 120. In the shown example, two first grooves 114 are formed.

The number of the first grooves 114 is not particularly limited. Although not shown, three or more first grooves 114 may be formed, or only one first groove 114 may be formed.

Although not shown, the plasticization unit 60 may include an elongated in-line screw having a spiral groove in a side surface thereof instead of the flat screw 110. The plasticization unit 60 may plasticize the material by rotation of the in-line screw.

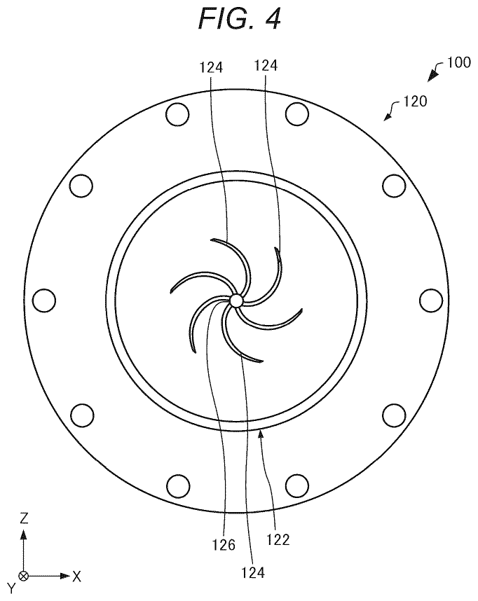

As shown in FIG. 2, the barrel 120 is provided to face the flat screw 110. The barrel 120 has a facing surface 122 facing the groove formation surface 112 of the flat screw 110. The facing surface 122 faces the groove formation surface 112 in the Y-axis direction. The communication hole 126 is formed at a center of the facing surface 122. Here, FIG. 4 is a view schematically showing the barrel 120.

As shown in FIG. 4, second grooves 124 and the communication hole 126 are formed in the facing surface 122 of the barrel 120. A plurality of second grooves 124 are formed. In the shown example, six second grooves 124 are formed, and the number of the second grooves 124 is not particularly limited. The plurality of second grooves 124 are formed around the communication hole 126 when viewed from the Y-axis direction. The second grooves 124 each have one end coupled to the communication hole 126 and extend in a spiral shape from the communication hole 126 toward an outer periphery of the facing surface 122. The second grooves 124 have a function of guiding the shaping material to the communication hole 126. The communication hole 126 allows the plasticized material to flow out of the barrel 120.

A shape of the second groove 124 is not particularly limited and may be, for example, a linear shape. The one end of the second groove 124 may not be coupled to the communication hole 126. Further, the second groove 124 may not be formed in the facing surface 122. However, in consideration of efficiently guiding the shaping material to the communication hole 126, the second groove 124 may be formed in the facing surface 122.

As shown in FIG. 2, the heater 130 is provided in the barrel 120. The heater 130 heats the material supplied between the flat screw 110 and the barrel 120. The heater 130 heats the material supplied to the first grooves 114. The heater 130 is controlled by the control unit 50. The plasticization unit 60 generates the shaping material by heating the material while conveying the material toward the communication hole 126 and causes the generated shaping material to flow out from the communication hole 126 to the injection mechanism 70 by the flat screw 110, the barrel 120, and the heater 130.

The injection mechanism 70 includes, for example, a cylinder 72, a plunger 74, and a plunger drive unit 79. The cylinder 72 is a substantially cylindrical member coupled to the communication hole 126. The plunger 74 is provided in the cylinder 72. The plunger 74 moves inside the cylinder 72. The plunger 74 is driven by the plunger drive unit 79 implemented by a motor, a gear, or the like. The control unit 50 controls the plunger drive unit 79 and the plasticization unit 60.

The injection mechanism 70 performs a metering operation and an injection operation by causing the plunger 74 to slide in the cylinder 72. The metering operation refers to an operation in which the shaping material located in the communication hole 126 is guided into the cylinder 72 by moving the plunger 74 in a −X-axis direction away from the communication hole 126 and is metered in the cylinder 72. The injection operation refers to an operation of injecting the shaping material in the cylinder 72 to the mold unit 30 through the nozzle 80 by moving the plunger 74 in a +X-axis direction approaching the communication hole 126.

A nozzle hole 82 is formed in the nozzle 80. The nozzle hole 82 communicates with the communication hole 126. The nozzle 80 injects the shaping material supplied from the plasticization unit 60 toward a mold 32 of the mold unit 30. Specifically, by performing the metering operation and the injection operation described above, the shaping material metered in the cylinder 72 is sent from the injection mechanism 70 to the nozzle hole 82 through the communication hole 126. Then, the shaping material is injected from the nozzle hole 82 to the mold unit 30.

The nozzle hole 82 and the communication hole 126 form a flow path 140 through which the shaping material flows. In the shown example, a longitudinal direction of the flow path 140 is the Y-axis direction. The cylinder 72 is coupled to the flow path 140. The cylinder 72 extends in a direction intersecting the longitudinal direction of the flow path 140. In the shown example, the cylinder 72 extends in the X-axis direction.

The mold unit 30 includes the mold 32. The mold 32 is a metal mold. The shaping material sent to the nozzle hole 82 is injected from the nozzle hole 82 into a cavity 34 of the mold 32. Specifically, the mold 32 includes a movable mold 36 and a fixed mold 38 facing each other and includes the cavity 34 between the movable mold 36 and the fixed mold 38. The cavity 34 is a space corresponding to the shape of the molded article. Materials of the movable mold 36 and the fixed mold 38 are metal. The materials of the movable mold 36 and the fixed mold 38 may be ceramic or resin.

The mold clamping unit 40 includes, for example, a mold drive unit 42 and a ball screw unit 44. The mold drive unit 42 is implemented by, for example, a motor, a gear, or the like. The mold drive unit 42 is coupled to the movable mold 36 via the ball screw unit 44. The mold drive unit 42 is controlled by the control unit 50. The ball screw unit 44 transmits power caused by driving of the mold drive unit 42 to the movable mold 36. The mold clamping unit 40 opens and closes the mold unit 30 by moving the movable mold 36 by the mold drive unit 42 and the ball screw unit 44.

### 1.3. Operations

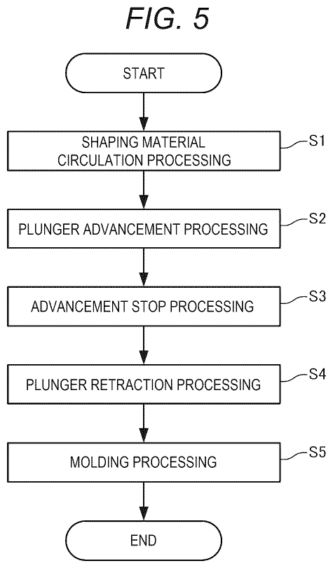

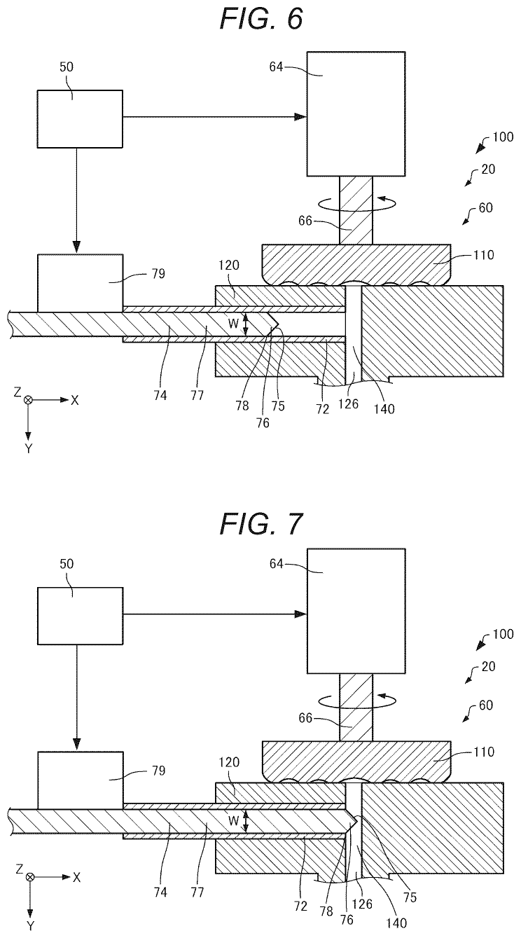

FIG. 5 is a flowchart showing operations of the injection molding apparatus 100. Specifically, FIG. 5 is a flowchart showing processing of the control unit 50. FIGS. 6 and 7 are cross-sectional views showing the processing of the control unit 50.

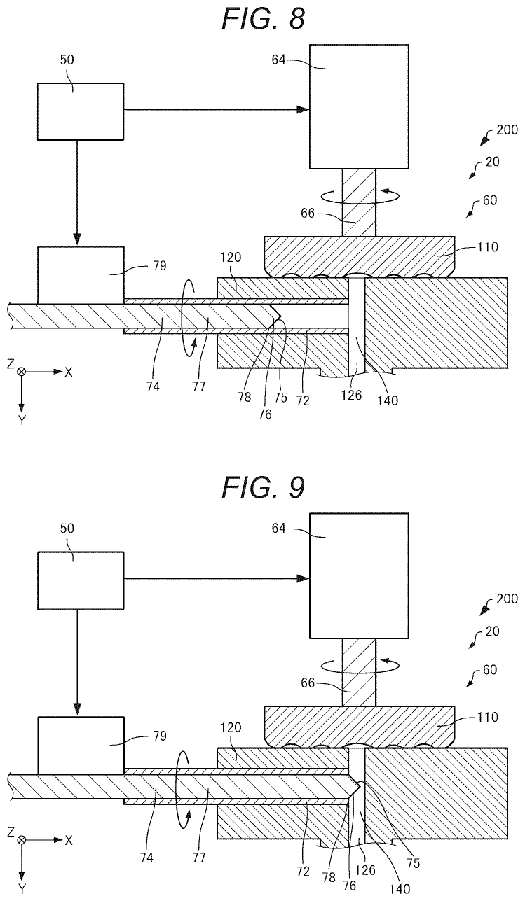

For convenience, illustration of members other than the control unit 50, the drive motor 64, the cylinder 72, the plunger 74, the plunger drive unit 79, the flat screw 110, and the barrel 120 is omitted in FIGS. 6 and 7. The flat screw 110 and the barrel 120 are shown in a simplified manner. This is the same in FIGS. 8 and 9 to be described later.

When the material stored in the material supply unit 10 is replaced from a first material to a second material, a user operates an operation unit (not shown) to output a processing start signal for starting the processing to the control unit 50. The operation unit is implemented by, for example, a mouse, a keyboard, or a touch panel. When receiving the processing start signal, the control unit 50 starts the processing.

The second material is a material different from the first material. The second material may be a material different in type from the first material. For example, the first material is acrylonitrile butadiene styrene (ABS) resin, and the second material is polypropylene (PP). The second material may be a material different in color from the first material. For example, the first material and the second material are both ABS resin, and the second material is different in color from the first material.

First, the control unit 50 performs cleaning processing. As shown in FIG. 5, the cleaning processing includes, for example, shaping material circulation processing, plunger advancement processing, advancement stop processing, and plunger retraction processing. In other words, the control unit 50 performs the shaping material circulation processing, the plunger advancement processing, the advancement stop processing, and the plunger retraction processing in the cleaning processing. In step S1, the control unit 50 performs the shaping material circulation processing of circulating the shaping material generated by plasticizing the second material through the flow path 140 by rotating the flat screw 110. The control unit 50 performs the shaping material circulation processing during the plunger advancement processing, the advancement stop processing, and the plunger retraction processing to be described later.

Specifically, the control unit 50 controls the drive motor 64 to rotate the flat screw 110, controls the heater 130 to plasticize the second material, and circulates the generated shaping material through the flow path 140. A rotation speed of the flat screw 110 is, for example, more than 0 rpm and 120 rpm or less. A rotational speed of the flat screw 110 in the shaping material circulation processing is, for example, larger than a rotational speed of the flat screw 110 in molding processing to be described later.

Next, in step S2, the control unit 50 performs the plunger advancement processing of advancing the plunger 74.

Specifically, the control unit 50 controls the plunger drive unit 79 to advance the plunger 74 until the tip 75 is located in the flow path 140 shown in FIG. 7 from a state in which a tip 75 of the plunger 74 is not located in the flow path 140 shown in FIG. 6. In the shown example, the control unit 50 moves the plunger 74 in the +X-axis direction.

The term “advance” refers to moving the plunger 74 closer to the flow path 140. The term “retract” refers to moving the plunger 74 away from the flow path 140.

The tip 75 is an end of the plunger 74 on a flow path 140 side. The tip 75 is a part that faces the flow path 140. The plunger 74 includes, for example, a tapered portion 76 in which a width W decreases toward the flow path 140 side and a constant width portion 77 in which the width W is constant toward the flow path 140 side. The width W is a size in a direction orthogonal to a longitudinal direction of the plunger 74. In the shown example, the width W is a size in the Y-axis direction. A shape of the tapered portion 76 is, for example, a cone. Although not shown, an apex of the cone may be rounded. The tip 75 is implemented by the tapered portion 76. In the shown example, the tip 75 is a surface of the tapered portion 76. A corner 78 is formed at a boundary between the tapered portion 76 and the constant width portion 77.

Although not shown, the plunger 74 may have a columnar shape. In this case, the tip 75 is an end surface of the plunger 74 on the flow path 140 side that faces the flow path 140.

Next, in step S3, the control unit 50 performs the advancement stop processing of stopping the advancement of the plunger 74 and locating the tip 75 of the plunger 74 in the flow path 140. By the advancement stop processing and the shaping material circulation processing, in a state in which the tip 75 of the plunger 74 is located in the flow path 140, the control unit 50 can circulate the shaping material generated by plasticizing the second material through the flow path 140 by rotating the flat screw 110 and can clean the tip 75.

Specifically, the control unit 50 controls the plunger drive unit 79 to stop the plunger 74 from advancing in a state in which the tip 75 is located in the flow path 140. For example, the control unit 50 positions the entire tapered portion 76 in the flow path 140. The control unit 50 maintains the state in which the tip 75 of the plunger 74 is located in the flow path 140 for a predetermined time.

Next, in step S4, the control unit 50 performs the plunger retraction processing of retracting the plunger 74. The control unit 50 can perform the plunger movement of advancing and retracting the plunger 74 by the plunger advancement processing and the plunger retraction processing while circulating the shaping material generated by plasticizing the second material through the flow path 140 by rotating the flat screw 110.

Specifically, the control unit 50 controls the plunger drive unit 79 to retract the plunger 74 to a position at which the tip 75 is separated from the flow path 140 shown in FIG. 6 from a state in which the tip 75 of the plunger 74 is located in the flow path 140 shown in FIG. 7. In the shown example, the control unit 50 moves the plunger 74 in the −X-axis direction.

Next, in step S5, the control unit 50 performs the molding processing of molding the molded article by dispensing the shaping material generated by plasticizing the second material by rotating the flat screw 110.

Specifically, the control unit 50 controls the drive motor 64 to rotate the flat screw 110, controls the heater 130 to plasticize the second material, and circulates the generated shaping material through the flow path 140. Then, the control unit 50 advances and retracts the plunger 74, performs the metering operation and the injection operation as described above, and molds the molded article by dispensing the shaping material into the cavity 34.

A rotational speed of the flat screw 110 in the cleaning processing is, for example, larger than the rotational speed of the flat screw 110 in the molding processing. The rotational speeds of the flat screw 110 in the plunger advancement processing, the advancement stop processing, and the plunger retraction processing are, for example, larger than the rotational speed of the flat screw 110 in the molding processing.

After performing the molding processing, the control unit 50 ends the processing.

The control unit 50 may repeat a series of processing including the plunger advancement processing, the advancement stop processing, and the plunger retraction processing a plurality of times.

Although an example in which the plunger advancement processing, the advancement stop processing, and the plunger retraction processing are performed while performing the shaping material circulation processing is described above, the control unit 50 may not perform the shaping material circulation processing between the plunger advancement processing and the plunger retraction processing as long as the tip 75 of the plunger 74 can be cleaned by performing the advancement stop processing while performing the shaping material circulation processing.

The control unit 50 may clean the tip 75 by performing the shaping material circulation processing after positioning the tip 75 of the plunger 74 in the flow path 140.

Further, the control unit 50 may stop the rotation of the flat screw 110 during a transition from the plunger retraction processing to the molding processing, or may transition to the molding processing without stopping the rotation of the flat screw 110.

### 1.4. Operation and Effect

In the material dispensing device 20, when the material is replaced from the first material to the second material different from the first material, the control unit 50 performs the cleaning processing of circulating the shaping material generated by plasticizing the second material through the flow path 140 by rotating the flat screw 110 in a state in which the tip 75 of the plunger 74 on the flow path 140 side is located in the flow path 140.

Therefore, in the material dispensing device 20, the shaping material generated by plasticizing the second material can be brought into contact with the tip 75 of the plunger 74. Accordingly, the tip 75 can be cleaned by the shaping material generated by plasticizing the second material. Therefore, it is possible to reduce a possibility that the first material before the replacement remains at the tip 75. As a result, the possibility that the first material remains in the molded article can be reduced, and the quality of the molded article can be stabilized.

Further, in the material dispensing device 20, even when the tip 75 of the plunger 74 is not cleaned with a purge material before the material is replaced from the first material to the second material, since the possibility that the first material before the replacement remains at the tip 75 can be reduced, a material replacement time can be shortened. When not considering the shortening of the material replacement time, in the material dispensing device 20, the tip 75 may be cleaned by the purge material before the first material is replaced with the second material.

Further, since a width of the flow path 140 is reduced when the tip 75 of the plunger 74 is located in the flow path 140, a flow velocity of the shaping material can be increased. Accordingly, a cleaning effect can be improved.

In the material dispensing device 20, the plunger 74 includes the tapered portion 76 in which the width W decreases toward the flow path 140, the tip 75 is implemented by the tapered portion 76, and the control unit 50 positions the entire tapered portion 76 in the flow path 140 in the cleaning processing. Therefore, in the material dispensing device 20, the entire tip 75 can be cleaned by the shaping material generated by plasticizing the second material.

In particular, in the vicinity of the corner 78 between the tapered portion 76 and the constant width portion 77, when the plunger 74 is advanced, the flow velocity is less than that at a center of the tapered portion 76 in the Y-axis direction. Therefore, the first material may remain in the vicinity of the corner 78 simply by advancing and retracting the plunger 74. In the material dispensing device 20, since the entire tapered portion 76 is located in the flow path 140 in the cleaning processing, such a problem can be avoided.

In the material dispensing device 20, the control unit 50 performs the molding processing of molding the molded article by dispensing the shaping material generated by plasticizing the second material by rotating the flat screw 110, and the rotational speed of the flat screw 110 in the cleaning processing is larger than the rotational speed of the flat screw 110 in the molding processing. Therefore, in the material dispensing device 20, compared to a case in which the rotational speed of the flat screw in the cleaning processing is less than the rotational speed of the flat screw in the molding processing, the cleaning effect of the tip 75 of the plunger 74 in the cleaning processing can be improved. As the rotational speed of the flat screw 110 increases, the flow velocity of the shaping material generated by plasticizing the second material increases, and the cleaning effect increases.

### 2. Modifications of Injection Molding Apparatus

### 2.1. First Modification

### 2.1.1. Operations

Next, an injection molding apparatus according to a first modification of the embodiment will be described with reference to the drawings. FIGS. 8 and 9 are cross-sectional views showing processing of the control unit 50 of an injection molding apparatus 200 according to the first modification of the embodiment.

Hereinafter, in the injection molding apparatus 200 according to the first modification of the embodiment, members having the same functions as the elements of the injection molding apparatus 100 according to the embodiment described above are denoted by the same reference numerals, and detailed description thereof is omitted. This is the same in injection molding apparatuses according to second and third modifications of the embodiment to be described later.

As shown in FIGS. 8 and 9, the injection molding apparatus 200 is different from the injection molding apparatus 100 in that the control unit 50 rotates the plunger 74 in cleaning processing. Specifically, in the injection molding apparatus 200, the control unit 50 rotates the plunger 74 in plunger advancement processing, advancement stop processing, plunger retraction processing, and molding processing.

As shown in FIG. 8, in the plunger advancement processing, the control unit 50 controls the plunger drive unit 79 to advance the plunger 74 while rotating the plunger 74.

As shown in FIG. 9, in the advancement stop processing, the control unit 50 controls the plunger drive unit 79 to stop the plunger 74 from advancing while maintaining the rotation of the plunger 74. In the advancement stop processing, the control unit 50 rotates the plunger 74 in a state in which the tip 75 of the plunger 74 is located in the flow path 140.

In the plunger retraction processing, the control unit 50 controls the plunger drive unit 79 to retract the plunger 74 while rotating the plunger 74. The control unit 50 can perform the plunger movement of advancing and retracting the plunger 74 while rotating the plunger 74 by the plunger advancement processing and the plunger retraction processing while circulating the shaping material generated by plasticizing the second material through the flow path 140 by rotating the flat screw 110.

In the molding processing, the control unit 50 controls the plunger drive unit 79 to advance and retract the plunger 74 while rotating the plunger 74.

When rotating the plunger 74 in each of the plunger advancement processing, the advancement stop processing, the plunger retraction processing, and the molding processing, the control unit 50 may rotate the plunger 74 normally and reversely. When rotating the plunger 74, the control unit 50 may rotate the plunger 74 counterclockwise after rotating the plunger 74 clockwise, or may rotate the plunger 74 clockwise after rotating the plunger 74 counterclockwise as viewed from the −X-axis direction. The control unit 50 may rotate the plunger 74 normally in the plunger advancement processing and may rotate the plunger 74 reversely in the plunger retraction processing.

A rotational speed of the plunger 74 in the cleaning processing is, for example, larger than a rotational speed of the plunger 74 in the molding processing. A rotational speed of the plunger 74 in the plunger advancement processing, a rotational speed of the plunger 74 in the advancement stop processing, and a rotational speed of the plunger 74 in the plunger retraction processing are, for example, larger than the rotational speed of the plunger 74 in the molding processing. As long as any one of the rotational speeds of the plunger 74 in the plunger advancement processing, the rotational speed of the plunger 74 in the advancement stop processing, and the rotational speed of the plunger 74 in the plunger retraction processing is larger than the rotational speed of the plunger 74 in the molding processing, the remaining rotation speeds may be equal to or less than the rotational speed of the plunger 74 in the molding processing.

In the plunger advancement processing, the advancement stop processing, and the plunger retraction processing, a ratio of the rotational speed of the flat screw 110 to a rotational speed of the plunger 74 is, for example, 3.6 or more and 5.6 or less. In other words, the rotational speed of the plunger 74: the rotational speed of the flat screw 110=1:3.6 to 1:5.6. When a mold clamping force of the injection molding apparatus 200 is 3 tons, a rotation speed of the plunger 74 is, for example, larger than 0 rpm and 675 rpm or less. When the mold clamping force of the injection molding apparatus 200 is 10 tons, the rotation speed of the plunger 74 is, for example, larger than 0 rpm and 432 rpm or less.

### 2.1.2. Operation and Effect

In the material dispensing device 20 of the injection molding apparatus 200, in the cleaning processing, the control unit 50 performs plunger movement processing of advancing and retracting the plunger 74 while rotating the plunger 74 while circulating the shaping material generated by plasticizing the second material through the flow path 140 by rotating the flat screw 110. Therefore, in the material dispensing device 20, the tip 75 of the plunger 74 can be cleaned by the plunger movement processing. Further, the shaping material can be attracted to the vicinity of a center of the tip 75 of the plunger 74 in the Y-axis direction by the rotation of the plunger 74, and the first material can be prevented from remaining in the vicinity of the corner 78.

In the material dispensing device 20 of the injection molding apparatus 200, the control unit 50 rotates the plunger 74 in the cleaning processing in a state in which the tip 75 is located in the flow path 140. Therefore, in the material dispensing device 20, it is possible to increase a region with which the shaping material generated by plasticizing the second material comes into contact compared to not rotating the plunger.

In the material dispensing device 20 of the injection molding apparatus 200, the control unit 50 rotates the plunger 74 normally and reversely. Therefore, in the material dispensing device 20, even when a shaping material cannot be peeled off by rotation in only one direction, it is possible to increase a possibility that the shaping material is peeled off from the tip 75 of the plunger 74 by rotation in the other direction.

In the material dispensing device 20 of the injection molding apparatus 200, the control unit 50 performs the molding processing of molding the molded article by dispensing the shaping material generated by plasticizing the second material by rotating the flat screw 110. In the molding processing, the plunger 74 is advanced and retracted while being rotated, and the rotational speed of the plunger 74 in the cleaning processing is larger than the rotational speed of the plunger 74 in the molding processing. Therefore, in the material dispensing device 20, compared to a case in which the rotational speed of the plunger in the cleaning processing is less than the rotational speed of the plunger in the molding processing, the cleaning effect of the tip 75 of the plunger 74 in the cleaning processing can be improved. As the rotational speed of the plunger 74 increases, a resistance from the shaping material which is a viscous body increases, and the cleaning effect increases.

In the material dispensing device 20 of the injection molding apparatus 200, a ratio of the rotational speed of the flat screw 110 to the rotational speed of the plunger 74 is 3.6 or more and 5.6 or less. Therefore, in the material dispensing device 20, the cleaning effect of the tip 75 of the plunger 74 can be improved.

### 2.2. Second Modification

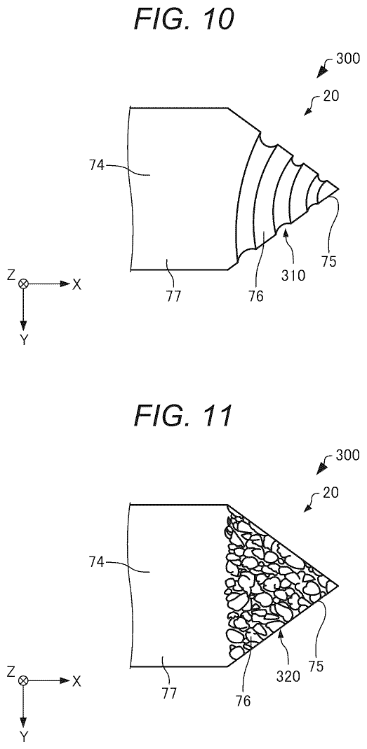

Next, an injection molding apparatus according to a second modification of the embodiment will be described with reference to the drawings. FIGS. 10 and 11 are side views of the plunger 74 of an injection molding apparatus 300 according to the second modification of the embodiment.

As shown in FIG. 10, the injection molding apparatus 300 is different from the injection molding apparatus 100 described above in that a spiral groove 310 is formed in the tip 75 of the plunger 74. When the plunger 74 is advanced and retracted, by the spiral groove 310, a shaping material can be attracted to the vicinity of a center of the tip 75 of the plunger 74 in the Y-axis direction, and the first material can be prevented from remaining in the vicinity of the corner 78.

In the injection molding apparatus 300, as shown in FIG. 11, an emboss 320 may be formed in the tip 75 of the plunger 74. The emboss 320 is formed by emboss processing. By the emboss 320, gaps can be formed between the shaping material and the tip 75, and the first material remaining on the tip 75 can be easily peeled off. Although not shown, both the spiral groove 310 and the emboss 320 may be formed in the tip 75.

In the material dispensing device 20 of the injection molding apparatus 300, at least one of the spiral groove 310 and the emboss 320 is formed in the tip 75 of the plunger 74. Therefore, in the material dispensing device 20, the cleaning effect of the tip 75 of the plunger 74 can be improved.

The tip 75 of the plunger 74 may be provided with a chromium nitride layer by performing a chromium nitride treatment. Further, a diamond like carbon (DLC) layer may be provided on the tip 75 of the plunger 74 by performing a DLC treatment. When the chromium nitride layer or the DLC layer is provided, the first material remaining on the tip 75 can be easily peeled off.

### 2.3. Third Modification

Next, an injection molding apparatus according to a third modification of the embodiment will be described.

In the injection molding apparatus 100 described above, a material supplied from the material supply unit 10 is ABS resin or PP.

In contrast, in the injection molding apparatus according to the third modification of the embodiment, a material supplied from the material supply unit 10 is a material other than the ABS resin and the PP, or a material obtained by adding other components to the ABS resin and the PP.

Examples of the material supplied from the material supply unit 10 include various materials such as a thermoplastic material, a metal material, and a ceramic material as main materials. Here, the term “main material” means a material serving as a core material for forming a shape of a molded article molded by the injection molding apparatus, and means a material having a content of 50% or more by mass in the molded article. The materials described above include materials obtained by melting the main materials alone and materials obtained by melting the main materials and a part of contained components into a paste shape.

As the thermoplastic material, for example, a thermoplastic resin can be used. Examples of the thermoplastic resin include general-purpose engineering plastic and super engineering plastic.

Examples of the general-purpose engineering plastic include polyethylene (PE), polyacetal (POM), polyvinyl chloride (PVC), polyamide (PA), polylactic acid (PLA), polyphenylene sulfide (PPS), polycarbonate (PC), modified polyphenylene ether, polybutylene terephthalate, and polyethylene terephthalate.

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyether ether ketone (PEEK).

In addition to a pigment, a metal, and a ceramic, an addition agent such as a wax, a flame retardant, an antioxidant, and a heat stabilizer may be mixed into the thermoplastic material. In the plasticization unit 60, the thermoplastic material is plasticized and converted into a molten state by rotation of the flat screw 110 and heating of the heater 130. The shaping material generated in this manner is deposited from the nozzle 80, and then is cured due to a decrease in temperature. It is desirable that the thermoplastic material is dispensed from the nozzle 80 in a completely molten state by being heated to a glass transition point or higher.

In the plasticization unit 60, for example, a metal material may be used as the main material instead of the thermoplastic material described above. In this case, it is desirable that a powder material obtained by powdering the metal material is mixed with a component that melts when the shaping material is generated, followed by being fed into the plasticization unit 60.

Examples of the metal material include a single metal such as magnesium (Mg), iron (Fe), cobalt (Co), chromium (Cr), aluminum (Al), titanium (Ti), copper (Cu), and nickel (Ni), or an alloy containing one or more of these metals, maraging steel, stainless steel, cobalt chromium molybdenum, a titanium alloy, a nickel alloy, an aluminum alloy, a cobalt alloy, and a cobalt chromium alloy.

In the plasticization unit 60, a ceramic material may be used as the main material instead of the metal material described above. Examples of the ceramic material include an oxide ceramic such as silicon dioxide, titanium dioxide, aluminum oxide, and zirconium oxide, and a non-oxide ceramic such as aluminum nitride.

The powder material of the metal material or the ceramic material supplied from the material supply unit 10 may be a mixed material obtained by mixing a plurality of types of powders of the single metal, powders of the alloy, or powders of the ceramic material. The powder material of the metal material or the ceramic material may be coated with, for example, the thermoplastic resin described above or another thermoplastic resin. In this case, in the plasticization unit 60, the thermoplastic resin may be melted to exhibit fluidity.

For example, a solvent may be added to the powder material of the metal material or the ceramic material supplied from the material supply unit 10. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetate (for example, tetrabutylammonium acetate); and ionic liquids such as butyl carbitol acetate.

In addition, for example, a binder may be added to the powder material of the metal material or the ceramic material supplied from the material supply unit 10. Examples of the binder include an acrylic resin, an epoxy resin, a silicone resin, a cellulose-based resin, other synthetic resins, PLA, PA, PPS, PEEK, and other thermoplastic resins.

### 3. Three-Dimensional Shaping Apparatus

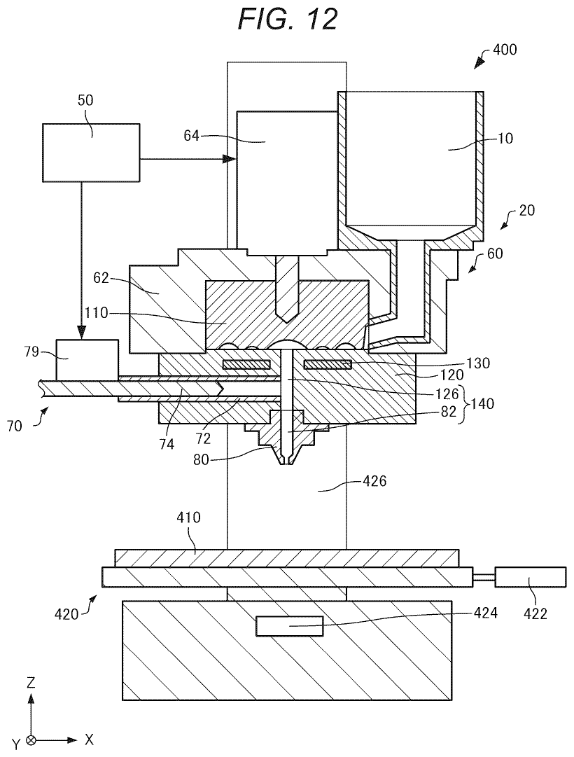

Next, a three-dimensional shaping apparatus according to the embodiment will be described with reference to the drawings. FIG. 12 is a cross-sectional view schematically showing a three-dimensional shaping apparatus 400 according to the embodiment.

As shown in FIG. 12, the three-dimensional shaping apparatus 400 includes, for example, the material supply unit 10, the control unit 50, the plasticization unit 60, the injection mechanism 70, the nozzle 80, a stage 410, and a position changing unit 420. The three-dimensional shaping apparatus 400 is a three-dimensional shaping apparatus of fused deposition modeling (FDM) (registered trademark) type.

The nozzle 80 dispenses the shaping material supplied from the plasticization unit 60 toward the stage 410. Specifically, the three-dimensional shaping apparatus 400 changes a relative position of the nozzle 80 and the stage 410 by driving the position changing unit 420 while dispensing the shaping material from the nozzle 80 to the stage 410. Accordingly, the three-dimensional shaping apparatus 400 shapes a three-dimensional shaped object as a molded article having a desired shape above the stage 410.

The injection mechanism 70 cuts stringing of the shaping material by advancing and retracting the plunger 74.

The stage 410 is provided below the nozzle 80. In the shown example, the stage 410 has a rectangular parallelepiped shape. The stage 410 supports the shaping material dispensed from the nozzle 80. A material of the stage 410 is, for example, a metal such as aluminum.

The position changing unit 420 supports the stage 410. The position changing unit 420 changes the relative position of the nozzle 80 and the stage 410. In the shown example, the position changing unit 420 changes the relative position of the nozzle 80 and the stage 410 in the X-axis direction and the Y-axis direction by moving the stage 410 in the X-axis direction and the Y-axis direction. Further, the position changing unit 420 changes the relative position of the nozzle 80 and the stage 410 in the Z-axis direction by moving the nozzle 80 in the Z-axis direction.

The position changing unit 420 includes, for example, a first electric actuator 422, a second electric actuator 424, and a third electric actuator 426. The first electric actuator 422 moves the stage 410 in the X-axis direction. The second electric actuator 424 moves the stage 410 in the Y-axis direction. The third electric actuator 426 moves the nozzle 80 in the Z-axis direction. The third electric actuator 426 supports, for example, the screw case 62 of the plasticization unit 60.

A configuration of the position changing unit 420 is not particularly limited as long as the relative position of the nozzle 80 and the stage 410 can be changed. For example, the position changing unit 420 may move the stage 410 in the Z-axis direction and move the nozzle 80 in the X-axis direction and the Y-axis direction, or may move the stage 410 or the nozzle 80 in the X-axis direction, the Y-axis direction, and the Z-axis direction.

The embodiment and the modifications described above are examples, and the present disclosure is not limited thereto. For example, the embodiment and the modifications may be combined as appropriate.

The present disclosure includes substantially the same configurations as the configurations described in the embodiment, such as a configuration having the same function, method, and result and a configuration having the same object and effect. The present disclosure includes a configuration in which a non-essential portion of the configuration described in the embodiment is replaced. The present disclosure includes a configuration capable of achieving the same operation and effect or a configuration capable of achieving the same object as the configuration described in the embodiment. In addition, the present disclosure includes a configuration obtained by adding a known technique to the configuration described in the embodiment.

The following contents are derived from the embodiment and the modifications described above.

In an aspect of a material dispensing device, the material dispensing device includes:
a plasticization unit including a screw and a heater and configured to generate a shaping material by plasticizing at least a part of a material;
a cylinder coupled to a flow path configured to allow the shaping material to flow and extending in a direction intersecting a longitudinal direction of the flow path;
a plunger provided in the cylinder;
a drive unit configured to drive the plunger; and
a control unit configured to control the plasticization unit and the drive unit, in which
when the material is replaced from a first material to a second material different from the first material, the control unit performs cleaning processing of circulating the shaping material generated by plasticizing the second material through the flow path by rotating the screw in a state in which a tip of the plunger on a flow path side is located in the flow path.

According to the material dispensing device, it is possible to reduce a possibility that the first material before the replacement remains at the tip of the plunger.

In an aspect of the material dispensing device,
the plunger may include a tapered portion in which a width decreases toward the flow path,
the tip may be implemented by the tapered portion, and
the control unit may position the entire tapered portion in the flow path in the cleaning processing.

According to the material dispensing device, the entire tip of the plunger can be cleaned by the shaping material generated by plasticizing the second material.

In an aspect of the material dispensing device,
in the cleaning processing, the control unit may perform plunger movement processing of advancing and retracting the plunger while rotating the plunger while circulating the shaping material generated by plasticizing the second material through the flow path by rotating the screw.

According to the material dispensing device, the tip of the plunger can be cleaned by the plunger movement processing.

In an aspect of the material dispensing device,
in the cleaning processing, the control unit may rotate the plunger in the state in which the tip is located in the flow path.

According to the material dispensing device, it is possible to increase a region with which the shaping material generated by plasticizing the second material comes into contact.

In an aspect of the material dispensing device, the control unit may rotate the plunger normally and reversely.

According to the material dispensing device, even when a shaping material cannot be peeled off by rotation in only one direction, it is possible to increase a possibility that the shaping material is peeled off from the tip of the plunger by rotation in the other direction.

In an aspect of the material dispensing device,
the control unit may perform molding processing of molding a molded article by dispensing the shaping material generated by plasticizing the second material by rotating the screw,
the plunger may be advanced and retracted while being rotated in the molding processing, and
a rotational speed of the plunger in the cleaning processing may be larger than a rotational speed of the plunger in the molding processing.

According to the material dispensing device, the cleaning effect of the tip of the plunger can be improved in the cleaning processing.

In one aspect of the material dispensing device,
at least one of a spiral groove and an emboss may be formed in the tip.

According to the material dispensing device, the cleaning effect of the tip of the plunger can be improved.

In an aspect of the material dispensing device,
the control unit may perform molding processing of molding a molded article by dispensing the shaping material generated by plasticizing the second material by rotating the screw, and
a rotational speed of the screw in the cleaning processing may be larger than a rotational speed of the screw in the molding processing.

According to the material dispensing device, the cleaning effect of the tip of the plunger can be improved in the cleaning processing.

In an aspect of the material dispensing device,
a ratio of a rotational speed of the screw to a rotational speed of the plunger may be 3.6 or more and 5.6 or less.

According to the material dispensing device, the cleaning effect of the tip of the plunger can be improved.

What is claimed is:

1. A material dispensing device comprising:
a plasticization unit including a screw and a heater and configured to generate a shaping material by plasticizing at least a part of a material;
a cylinder coupled to a flow path configured to allow the shaping material to flow and extending in a direction intersecting a longitudinal direction of the flow path;
a plunger provided in the cylinder;
a drive unit configured to drive the plunger; and
a control unit configured to control the plasticization unit and the drive unit, wherein
when the material is replaced from a first material to a second material different from the first material, the control unit performs cleaning processing of circulating the shaping material generated by plasticizing the second material through the flow path by rotating the screw in a state in which a tip of the plunger on a flow path side is located in the flow path.

2. The material dispensing device according to claim 1, wherein
the plunger includes a tapered portion in which a width decreases toward the flow path,
the tip is implemented by the tapered portion, and
the control unit positions the entire tapered portion in the flow path in the cleaning processing.

3. The material dispensing device according to claim 1, wherein
in the cleaning processing, the control unit performs plunger movement processing of advancing and retracting the plunger while rotating the plunger while circulating the shaping material generated by plasticizing the second material through the flow path by rotating the screw.

4. The material dispensing device according to claim 1, wherein
in the cleaning processing, the control unit rotates the plunger in the state in which the tip is located in the flow path.

5. The material dispensing device according to claim 3, wherein the control unit rotates the plunger normally and reversely.

6. The material dispensing device according to claim 3, wherein
the control unit performs molding processing of molding a molded article by dispensing the shaping material generated by plasticizing the second material by rotating the screw,
the plunger is advanced and retracted while being rotated in the molding processing, and
a rotational speed of the plunger in the cleaning processing is larger than a rotational speed of the plunger in the molding processing.

7. The material dispensing device according to claim 1, wherein
at least one of a spiral groove and an emboss is formed in the tip.

8. The material dispensing device according to claim 1, wherein
the control unit performs molding processing of molding a molded article by dispensing the shaping material generated by plasticizing the second material by rotating the screw, and
a rotational speed of the screw in the cleaning processing is larger than a rotational speed of the screw in the molding processing.

9. The material dispensing device according to claim 3, wherein
a ratio of a rotational speed of the screw to a rotational speed of the plunger is 3.6 or more and 5.6 or less.

10. An injection molding apparatus comprising:
the material dispensing device according to claim 1; and
a mold clamping unit configured to open and close a mold unit including a fixed mold and a movable mold.
